(19) United States
(12) Patent Application Publication
(10) Pub. No.: US 2008/0295101 A1
(43) Pub. Date: Nov. 27, 2008

(54) ELECTRONIC DOCUMENT MANAGER

(76) Inventors: Paul David Vicars, Dayton, OH (US); Eric James VanHoose, Dayton, OH (US)

Correspondence Address: DENNIS F ARMIJO, 6300 MONTANO RD. NW, SUITE D, ALBUQUERQUE, NM, 87120, US

(21) Appl. No.: 11/877,514

(22) Filed: Oct. 23, 2007

Related U.S. Application Data
(63) Continuation-in-part of application No. 11/044,434, filed on Jan. 27, 2005.
(60) Provisional application No. 60/853,973, filed on Oct. 24, 2006.

(51) Int. Cl. G06F 9/46

(52) U.S. Cl. 718/102

(57) ABSTRACT

A system and method for managing electronic files and tasks in a way that is intuitive to the users, mimicking their environment. The system and method comprises a configurable structure that facilitates the accurate filing and subsequent locating of electronic files in underlying document management/record management (DM/RM) applications, as well the utilization of business rules to manage a process. The manager enables users, with permissions, to communicate with each other regarding these files and their work through ad-hoc workflows that are created by the user as needed, then retained as documentation of events. The manager provides an efficient, secure, auditable handling of unstructured data that is free of predetermined inflexible processes and is not dependant on specific underlying document management software. The system also provides the users a method for measuring the timeliness of structured and unstructured data and processes on a perpetual, real time basis.

### CROSS-REFERENCE TO RELATED APPLICATIONS

This application is based on U.S. Provisional Application Ser. No. 60/853,973 entitled “Electronic Document Manager”, filed on Oct. 24, 2006, and is a continuation-in-part of U.S. patent application Ser. No. 11/044,434, entitled “Electronic Document Manager”, filed Jan. 27, 2005, the teachings of which are incorporated herein by reference.

### BACKGROUND OF THE INVENTION

1. Field of the Invention (Technical Field)

The present invention is in the field of Electronic Business Process Management (EM) and more particularly to embodiments for a system and methods for managing unstructured data in electronic files and workflows, embodied in a software application that takes advantage of the sophistication of independent document and record management tools while providing the user with a simplified interaction with those tools. This invention adds real time alerts and metrics to the structured and unstructured processes and data that are electronically managed, providing a perpetual status and accountability of the process.

2. Background Art

This invention discloses embodiments for a system and a software application for document-intensive work environments that: (1) provides a very user-friendly and easy to maintain “electronic intersection” between the underlying, existing document and record management software products through use of their APIs; (2) creates a folder centric “look and feel” that mirrors the user's existing processes for organizing their files; and (3) gives the user a unique, fast and easy to use means of collaborating with others through use of the EM workflow and shared file access.

In businesses without document/record management software, files are still maintained as paper copies stored in filing cabinets or boxes. If records are stored electronically, either in lieu of or in addition to paper copies, their organization is usually haphazard. Both methods continue to increase resource requirements, inhibit collaboration, and create security and accountability concerns. However, transition to a paperless work environment is slow or non-existent because existing document management and record management software is inflexible and cumbersome.

The disclosed embodiments solve this functional problem that manifests itself in the limitations of both the paper processes and in the document and record management products currently available. This problem is especially prevalent in those document-intensive work environments where there are whole organizations or departments of people that are currently inundated with the flow of paper. In order to be efficient and successful, a transition to a new method of record keeping must not force inappropriate and intrusive changes to an organization's current processes. Further, the tool which is employed must be easy to learn at the outset and simple to use for everyone.

The prior art methods found in existing document/record management software may provide acceptable document and record management functionality to the computer savvy. These tools are not for the user who just wants to use the software to get their work accomplished. Unlike EM, these methods do not provide a means of quickly setting up a structure that mirrors the existing paper file plan of the user or provide an easy way to send ad-hoc workflows to collaborate with other users.

The solution to the above problem is an out-of-the-box solution that is designed to emulate existing processes. EM provides this with easily modifiable table-driven setup that can be managed by the user's system administrator. Not only does this allow initial implementation to happen quickly, it ensures that as a business grows and/or changes its processes, the EM solution will run along side. This is the challenge that the existing software products have failed to recognize.

EM does not require an understanding of the user's processes but provides a table-driven capability to quickly capture the user's file plan as a process enabler. EM provides a folder centric look and feel for the user, which allows the user to file their documents (in their document management software) according to the file plan with which they are familiar. The documents in the file plan can then be secured as an entity (or folder) so that they cannot be altered or changed (from their record management software). This allows these documents to be kept electronically together as one secure bundle. The filing of these documents triggers the capture of basic foundational metric and measurement data that can be used in business process re-engineering. EM also gives the user predetermined permission to visit other users' folders for information, sharing, etc. This ability to share information by establishing guest privileges for the various users in a workplace allows collaboration to occur without the need to always send a workflow.

A user can establish fixed reusable workflows in EM if desired. However, EM provides the user with the greater ability to send workflows almost instantly without having to establish a fixed, inflexible workflow map. These ad-hoc workflows can be directed to whomever the user chooses by simply selecting the correct user names, group, or function and any files that he'd like to send for review and/or coordination. Such ad-hoc workflows can be reassigned and/or cancelled after they are launched, accommodating the flexibility required in today's dynamic workplace. This ad-hoc workflow capability allows the user to process data and/or documents that have no predictable, unchanging process flow without EM being required to pre-define the workflow with a specific process map, yet still leaving a clear audit trail of the activity that occurred. Other than EM, there are no ad-hoc workflow software products today with these capabilities.

The embodiments of this invention also provide a continuous, “quick reference” means of knowing the status of the process and data being managed without the need for custom programming or data compilation. This status is provided by electronic alerts to the users affected and metric measurement of the process monitored.

This is in contrast to the current business practices for managing these unstructured processes that do not have a predictable, always-repeatable, precise flow of the work being processed. Current practices find these business processes being managed in paper folders or electronically by e-mail and share drives. These practices do not provide a way to have real time, perpetual status since the precise process itself is not predictable and repeatable. Knowing on a perpetual basis the status of the unstructured process as being: (1) on time; (2) becoming late; or (3) late has not been possible before this invention. A typical example of prior art systems is described in U.S. Pat. No. 5,819,295 to Nakagawa. This system is a document management system for moving or deleting older versions of documents in a file, automatically when a new folder is made. This device does not manage documents as part of an ongoing and dynamic process, as is disclosed in this patent application.

The present invention solves this functional problem that manifests itself in the limitations of both the paper and share drive/e-mail processes currently available. In order to be efficient and successful, a transition to a new method of monitoring a dynamic process must not force inappropriate and intrusive changes to an organization's current processes. Further, for acceptance, the tool which is employed must be easy to learn at the outset and simple to use for everyone.

Current methods can be found in existing document/record management software that may provide acceptable status of structured, predictable processes but does not provide such a status for unstructured processes. Since 85% of the documents and processes are unstructured in an office environment, these products are missing the opportunity to provide vital statuses and metrics on most of an organization's workload. These tools do not provide a means to quickly set up a measurement structure that monitors the unstructured process flow.

The preferred solution to the above problem is an out-of-the-box solution that is designed to emulate the existing, structured and unstructured processes and their measurement. EM provides this with easily modifiable table-driven metrics setup that can be managed by the user. Not only does this allow initial implementation to happen quickly, it ensures that as a business grows and/or changes its alerts and metrics, the EM solution will run alongside. Furthermore, EM provides a complete, real time status of all of the structured and unstructured processes within an organization that current products and practices are not capturing. This is the challenge that the existing software products have failed to recognize.

EM does not require an understanding of the user's process metrics, but provides a table-driven capability to allow the user to quickly set up the various structured and unstructured processes' alerts and metrics for measurement as a process enabler. Once these process standards are set up, EM will monitor the status of the process for its timeliness.

### SUMMARY OF THE INVENTION

### Disclosure of the Invention

The embodiments of the present invention are systems and software applications that interface with and integrate existing document and record management software products. They provide the end-user with the tools that facilitate secure management of their electronic unstructured data files from creation through collaboration to final permanent record storage. The methods used create an interface that mimics the way work is currently done yet is free from predefined inflexible processes.

The disclosed embodiments draw a folder centric structure around electronic file storage that is easily configured for each installation. The model for this folder structure is typically an existing file plan. As a result, the user interface is immediately familiar to the end-user. There is no limit to the number of folder patterns that can exist in any given installation. Each functional area within an organization can be configured uniquely for its purposes.

The folder pattern is subdivided into sections and tabs that relate to the specific documents or files that will potentially be stored. Within each functional area's folder pattern, permission levels are established for actions that occur at the folder and at the individual tabs. Users are then assigned, with appropriately varying permissions, to one or more functional areas where they will do work.

An electronic file placed in the document management database is accessible to the user, if he has the correct permissions, for viewing, editing, copying, moving, or deleting until a user, again with correct permissions, deems that all work on a particular effort is done and “locks” the entire folder containing the document. The embodiment automatically retains all versions of a file that have existed during its life in EM. Each of these is available to the user for review. As a result of these file handling capabilities, the embodiments provide a realistic environment for managing work, not just a repository for completed files. It does, on the other hand, also provide a means for moving sets of files, by folder, to permanent record storage, assigning disposition dates, and deleting those folders when they have aged past their disposition date.

The disclosed embodiments provide the capability of issuing ad-hoc workflows. This allows a user to communicate with other users purely as needed, not in conformation with any predefined map or process. The workflow may be addressed to any user(s) the originator chooses and may carry electronic file attachments as well as instructions. Ad-hoc workflows are always related to a particular folder and retained after completion, adding a dimension of audit-ability.

In addition to file version control and workflow history, the invention has built-in methods for tracking events, which assure accountability. As a by-product, event tracking may provide data for any number of business management efforts.

In another embodiment of the Electronic Manager (EM) a status update is provided to the user. When managing processes and file structures with EM, the user often wants to know the status of the work product in terms of time and effort accomplished to know if the effort is being completed within the time planned. To date, this is particularly difficult for all efforts that have no predefined path for accomplishing the work. Such work efforts produce documents known as unstructured data, which comprise 85% of the work accomplished within an office. The disclosed embodiments allow the user to predefine specific time periods for accomplishment of the steps in this unstructured work effort. Once established, it monitors the progress, alerts the user of any potential or real time delinquencies and provides a continuous status of the progress automatically. Once a process for unstructured or structured data is established, it can be used repeatedly, or if desired, the process, alerts and the metrics can also be changed, on demand, without the need for programming. These new functions are referred to as a “real time” process since theses alerts and metrics can be provided perpetually and instantaneously throughout the process as it is being worked.

An object of the presently disclosed embodiments is to provide a folder centric look and feel for the user, which allows the user to place their electronic files into a document/record management database according to the file plan with which they are familiar.

An advantage of the disclosed embodiments is that it provides the user with the ability to send workflows almost instantly without having to establish a fixed, inflexible workflow map.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the disclosed embodiments. The drawings are only for the purpose of illustrating an embodiment of the invention and are not to be construed as limiting the invention. In the drawings:

FIG. 1 is an overview of the core features of the electronic document manager.

FIG. 2 is a screen shot of the user interface screen to add new folders.

FIG. 3 shows the process flow for creating new folders and a screen shot of a newly created folder and the identifying information that is customizable for each functional area by the customer.

FIG. 4 is a screen shot of a newly created folder showing the consistency of the automatically created tab structure for each folder in that functional area.

FIG. 5 is a screen shot of the user interface screen to import a new file.

FIG. 6 is a diagram showing that all kinds of electronic files can be used in conjunction with the electronic document manager.

FIG. 7 is a screen shot of the user interface screen to search for projects, showing the different criteria that the user can choose.

FIG. 8 is a screen shot of the user interface screen to search for folders, showing all the criteria used to select folders.

FIG. 9 is the process flow for searching for folders and projects and the types of results expected.

FIG. 10 is a screen shot of the workflow management screen, showing the criteria for searching workflows.

FIG. 11 shows the process flow for searching workflows and the expected results, along with status indicators.

FIG. 12 shows the user interface for creating ad-hoc workflows, and the different components that comprise the electronic document manager's ad-hoc workflow.

FIG. 13 shows the process flow for creating and executing the electronic document manager's workflows.

FIG. 14 shows the user interface for managing a workflow and its components.

FIG. 15 shows the user interface for executing a task within a workflow.

FIG. 16 shows the user interface for creating a memo and its components.

FIG. 17 shows the user interface for creating new projects and how it incorporates existing folders and applies identifying information to that project.

FIG. 18 shows the process flow for creating projects, and a screen shot of a newly created project and its components.

FIG. 19 shows sample entries in a chronological log for a particular folder.

FIG. 20 shows this invention's options for managing electronic files.

FIG. 21 shows the user interface for moving electronic files.

FIG. 22 shows the user interface for copying electronic files.

FIG. 23 shows the user interface for deleting electronic files.

FIG. 24 shows the properties of electronic files that are managed in the electronic document manager.

FIG. 25 shows the user interface for reviewing versions of electronic files.

FIG. 26 shows the folder characteristics and different symbols used to indicate some of the different states of the electronic files.

FIG. 27 shows the process for managing electronic files in folders for the full life cycle of the folder.

FIG. 28 shows the different stages of the folder for records management phases.

FIG. 29 shows the opening screen in the configuration tool used to search for and manage organizations.

FIG. 30 shows the configuration tool screen used to search for and manage functional areas.

FIG. 31 shows the user interface in the configuration tool used for editing and managing the functional areas.

FIG. 32 shows the configuration tool screen used to search for and manage sections.

FIG. 33 shows the user interface in the configuration tool used for editing sections.

FIG. 34 shows the configuration tool screen used to search for and manage tabs.

FIG. 35 shows the user interface in the configuration tool used for editing tabs.

FIG. 36 shows the configuration tool screen used to search for and manage users.

FIG. 37 shows the user interface in the configuration tool used for editing users and managing permission levels.

FIG. 38 shows the building blocks that make up the electronic document manager's total solution.

FIG. 39 shows one possible architecture implementation of the electronic document manager.

FIG. 40 shows the organizational structure behind the configuration tool.

FIG. 41 is an overview of the additions to the tool bar.

FIG. 42 is an overview of the home page content.

FIG. 43 shows the user interface screen to manage alerts history.

FIG. 44 shows the user interface screen to manage folder metrics.

FIG. 45 shows the user interface screen to manage section metrics.

FIG. 46 shows the new user interface screen to manage folder monitors.

FIG. 47 illustrates the links feature.

FIG. 48 shows the new configuration tool screen for setting up business rules dealing with permissions and folder level metrics.

FIG. 49 shows the configuration tool screen for setting up business rules for sections and section level metrics.

FIG. 50 is a flowchart explaining the metrics process.

### DESCRIPTION OF THE PREFERRED EMBODIMENTS

### Best Modes for Carrying Out the Invention

The embodiments of the present invention involve a system and/or method for managing electronic files in a way that is intuitive to the users, mimicking their environment. Further, the disclosed embodiments enable the use of ad-hoc workflows, by-passing the need for specifically predefined workflow maps. These embodiments are particularly suited to the management of unstructured data.

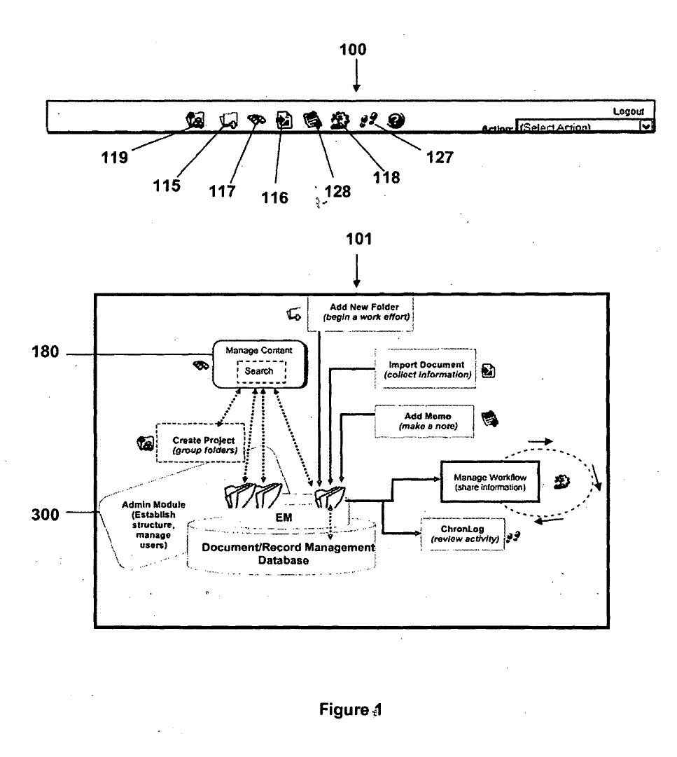

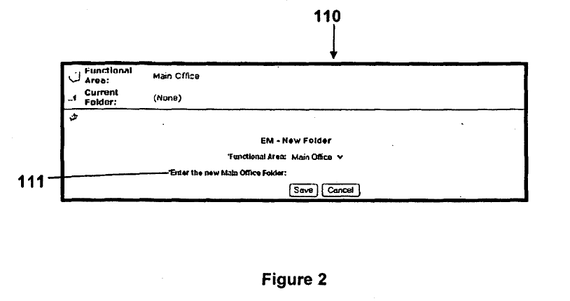

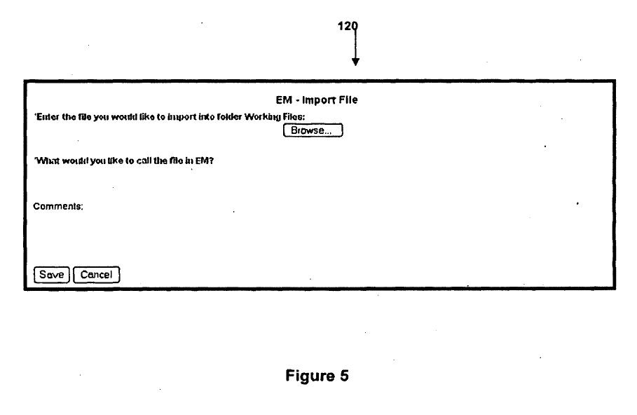

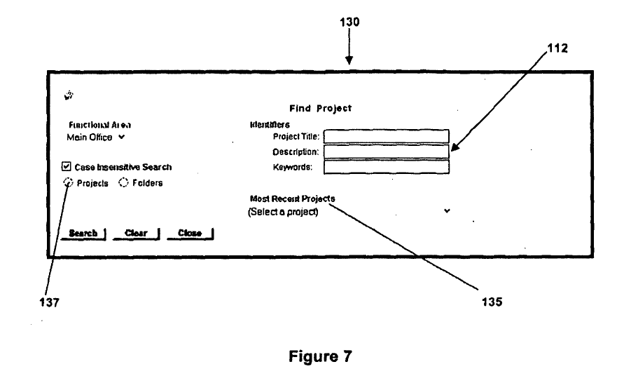

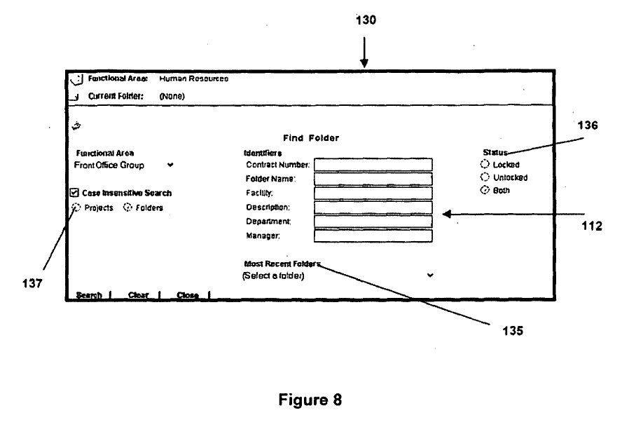

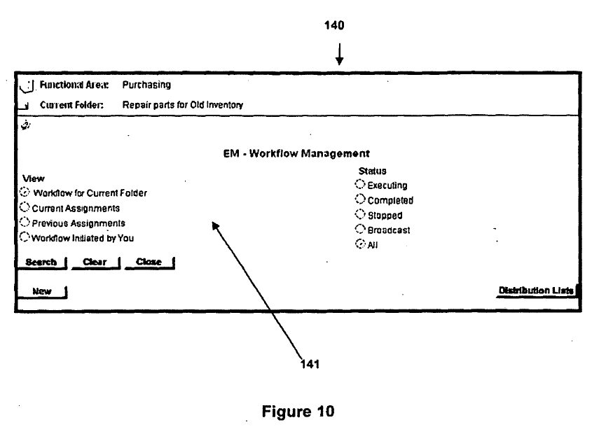

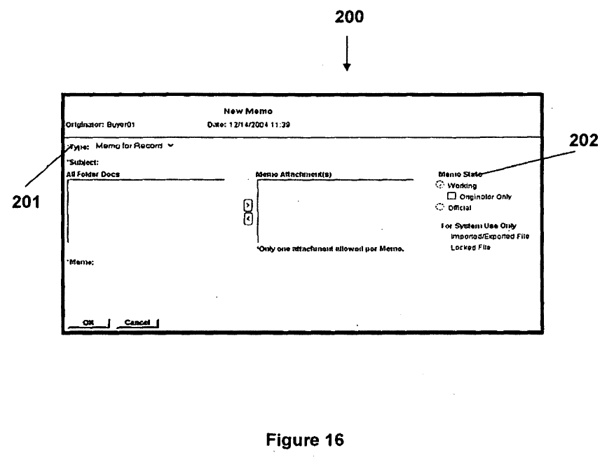

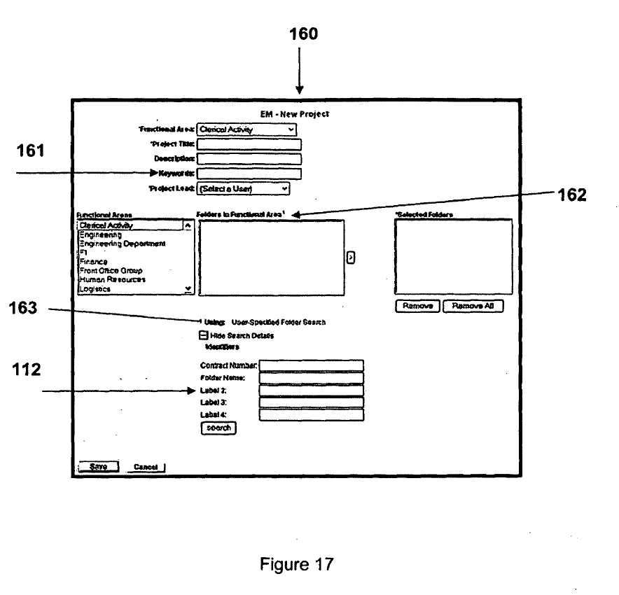

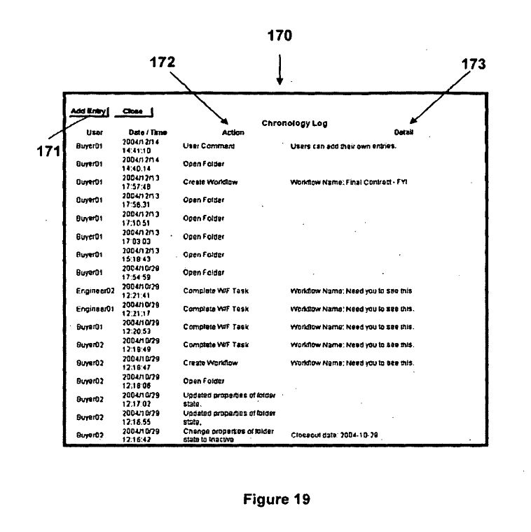

FIG. 1 shows menu bar 100 used in one embodiment with identification of key features accessible from the menu's icons. Create project icon 102 references the action described in FIG. 17. New folder icon 103 references the action described in FIG. 2. Search icon 104 references the action described in FIGS. 7 and 8. Import document icon 105 references the action described in FIG. 5. Add memo icon 106 references the action described in FIG. 16. Workflow management icon 107 references the action described in FIG. 10. Chron log icon 108 references the action described in FIG. 19.

Diagram 101 represents the way these features are used by EM in its role as emissary between the user and the under-lying document/record management database. Configuration tool 300 is the foundation upon which the invention operates. Configuration tool 300 allows the user to enter business rules that define the structure of their process. This embodiment uses those user-defined values to create the user-interface that the EM user will see, and which is described by the following Figures in conjunction with FIG. 1. The EM user interface is used to capture and retain to capture user data. This embodiment utilizes a document/record management database and performs multiple activities. Individual elements numbered from 102 through 300 are discussed in detail with ensuing figures.

FIG. 2 shows an example of the first step a user performs as he begins to work in the application: the creation of a new folder 110. The user may name folder 111, shown in FIG. 2, as he chooses. Typically, folder name 111 will correspond to a work-effort for which documents will be stored.

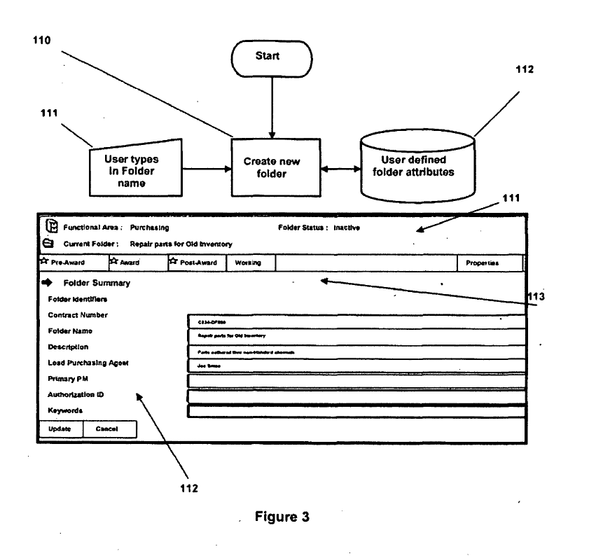

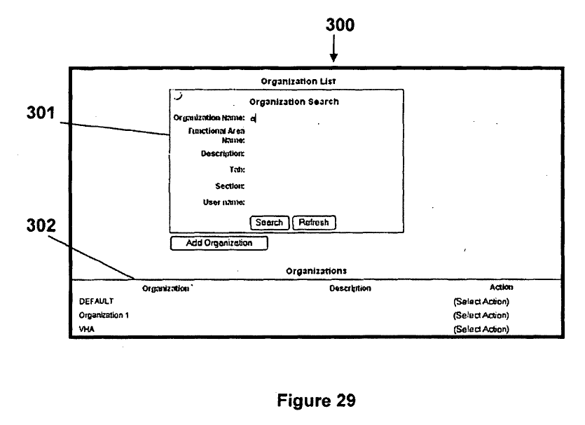

A diagram of the folder creation process and a view of a newly created folder are shown in FIG. 3. New folders, identified primarily by the user entered folder name 111, shown in FIG. 2, acquire a structure predefined in the configuration tool (see FIGS. 29-37, and FIGS. 48-49) that includes user defined folder attributes or identifiers 112, and includes sections 113 that are applied consistently, each time a new folder 110 is created. As shown in the screen shot in FIG. 3, folder identification box 111c lets the user confirm which folder is open; the user may fill in values for each of the folder identifiers 112, for each created folder. The folder name is entered in user interface 111b, shown in FIG. 2 and then added to the embodiment's database 112b. The user defined identifiers are added to the embodiment's database 112b. Along with identifiers 112 and sections 113, a user-defined set of tabs is applied to each folder, giving users a filing structure complete with applied permission levels for storage of electronic files.

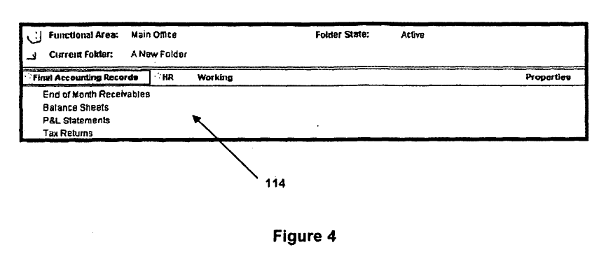

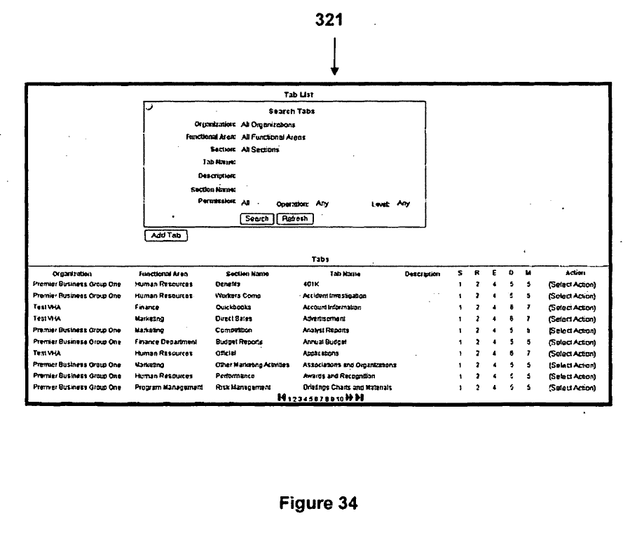

This is shown in FIG. 4. Each section has its own user-defined tab structure 114. The tabs are created using the configuration tool as shown in FIG. 34.

To facilitate the method of bringing in new files, once a folder has been created, this embodiment uses an import feature, as shown in FIG. 5, which will import 120 any electronic file.

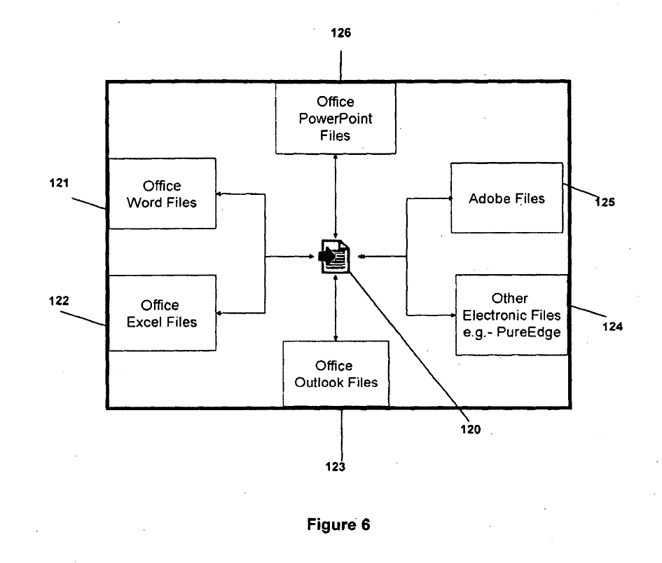

FIG. 6 is a diagram that depicts different types of electronic files that can be imported with this embodiment. FIG. 5 illustrated the user interface for importing new documents 120. As shown in FIG. 6, these can include office Word files 121, office Excel files 122, office Power Point files 126, Adobe files 125, Office Outlook messages 123 and other electronic files 124. Although, these electronic files are listed above, this is not meant to limit the type of files that can be used. This application will utilize the associated application within the operating system of the local personal computer (PC) to access any electronic file. For example, if a .pdf file 125 is accessed within this embodiment, the version of Adobe Acrobat Reader™ that is associated with .pdf files within the operating system and installed on the local PC will be used to view that file.

The purpose of identifiers 112, as shown in FIGS. 7 and 8, is to assist users later in locating specific folders, projects, and documents (not shown). Identifiers 112 are fully configurable by the user. The user defines them in configuration tool 300, which is referenced in FIG. 1. FIG. 7 details a project search 130a feature. The user is given an option to choose whether to search for projects or for folders 137. When project is selected, the user sees the screen in FIG. 7. If a user chooses to use an identifier 112 such as a customer number, each customer can be assigned to a folder and be found by searching for that specific customer number. As another example, if a user chooses a customer type to be used as an identifier 112, all projects or folders that are associated to that customer type can be found by searching for that specific value. Searches performed with these identifiers 112 are indicated in FIG. 7, which illustrates project searches, and FIG. 8, which illustrates folder searches. Alternately, the user may select a project from the 5 most recent projects 135 he has opened.

FIG. 8 details the embodiment's folder search 130b feature. The user is given an option to choose whether to search for projects, documents (not shown) or folders 137. When folder is selected, the user sees the screen on FIG. 8. Similar to the project search, the user can choose to use a pre-defined, user configured identifier 112 such as a customer number. Each customer can be assigned to a folder and be found by searching for that specific customer number. The user can refine folder search 130b with status type indicators 136. Alternately, the user may select a folder from the 5 most recent folders 135b he has opened. As another example, if a user chooses a customer type to be used as an identifier 112, all projects or folders that are associated to that customer type can be found by searching for that specific value. Searches performed with these identifiers 112 are indicated in FIG. 7, which illustrates project searches, and FIG. 8, which illustrates folder searches.

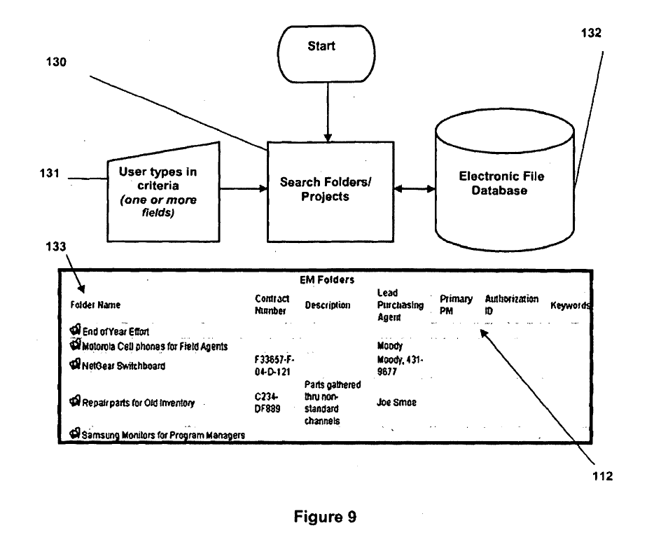

The entire search process 130 for this embodiment is shown in FIG. 9. The user provides criteria 131 for the search. Search process 130 retrieves information from database 132 for all folders which satisfy criteria 131, and displays a list 133 of those folders, documents (not shown), or projects which includes all of their identifiers 112.

FIG. 10 shows the workflow management screen presented to users, allowing them to choose to search for workflows 140. The user can search for workflows associated with a specific folder, workflows currently assigned to them, workflows previously assigned to them, or workflows they have initiated. Each of these classifications of workflows can be further limited by selecting a particular workflow status. Taken together, these are called selections of the workflow search criteria 141.

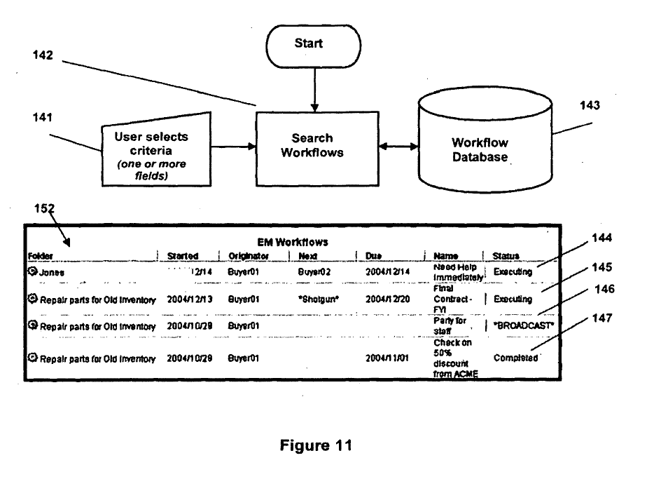

FIG. 11 shows the workflow search process flow 140b. Search criteria 141b provided are used to select from workflow database 143. The results are displayed in workflow list 152. This list of workflows 152 also includes a color coding of the status of each workflow. Examples in the list included in FIG. 11 are a workflow that is still executing but is past due in a first color (not shown) 144, a workflow that is still executing and has at least 2 (a configurable number) more days until its due date in a second color (not shown) 145, a broadcast workflow needing no action in a third color (not shown) 146, and a completed workflow in a fourth color (not shown) 147. Although different colors are described, other identifiers can be used. The color and time are for the purpose of illustrating an embodiment of the invention and not to be construed as limiting the invention.

This embodiment uses ad-hoc workflows, meaning that workflows are used on an as-needed basis. In the underlying document manager, or workflow manager, workflow maps are created with blank information that is filled in as the workflow is used. In the user interface, each new workflow allows the creator to select the recipients, to select the order of the recipients, and to attach relevant documents.

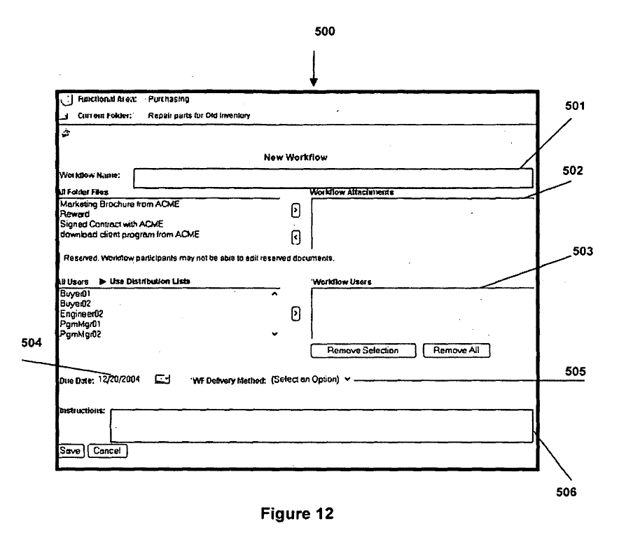

FIG. 12 shows user interface 500 that is used to fill in workflow parameters. The user types in a name for workflow 501. The user may select one or more electronic files from all folder files 502b to be copied as attachments to the workflow, by highlighting the file and then selecting migration button 502c. The user will now see the attachments in workflow attachments box 502. The user selects the recipients who will receive the workflow from either users list 503b or distribution list 503c, then selects migration button 503d. The user will now see the users in workflow users list 503. The user selects a due date 504 for the workflow that will be used to track against and to show the status of the workflow. The user selects the delivery method for workflow 505. This embodiment includes different types of delivery methods such as “sequential” where, in the order in which they appear in the selected list of users, each recipient receives his part of the workflow only after the previous recipient completes his part, “shotgun” workflows where the workflow is sent to all the recipients at the same time, and “broadcast” where the workflow is sent as an information workflow only, not requiring any completion of any tasks. The user provides instructions for recipients 506. As the workflow is saved and made available to the recipients, e-mail notifications are sent to the appropriate users.

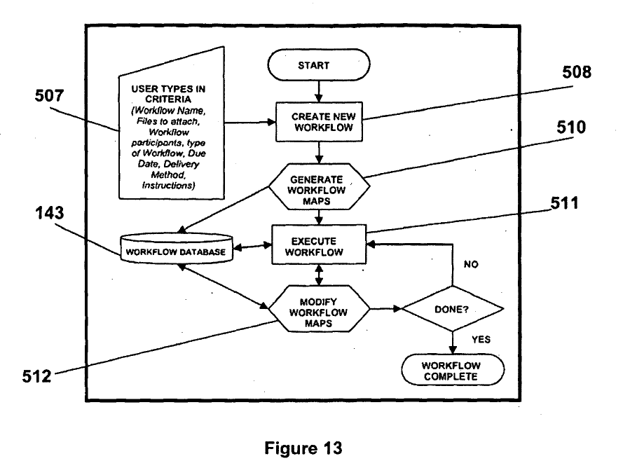

FIG. 13 shows the process flow of an ad-hoc workflow. Pre-mapped blank workflows exist in the underlying document management or workflow management database 143. A user creating a workflow is completely unaware of this. He provides the information necessary to make an instance of a workflow specific to his needs 507. When he submits or saves his work, i.e. completes the creation of his workflow 508, the application adds the resulting workflow map 510 to workflow database 143. As the workflow is executed 511, that is designated recipients of the workflow access it, workflow map is modified 512 to reflect action that has been taken. This action will potentially include the addition of more document attachments and the reassignment of work by a recipient to some other user. It will include the comments each recipient is required to enter and the recording of the change of status from executing to complete. Note that completed workflows are not removed from the workflow database.

The benefit of utilizing an ad-hoc type of workflow is to eliminate complexity for the end user. Eighty-five percent (85%) of the work done with workflows can be accomplished with fifteen percent (15%) of the complexity. So, pre-mapped blank workflows allow the user maximum flexibility with a minimal amount of complexity to get the majority of their work accomplished. This is based on the assumption that eight-five percent (85%) of the work performed in any given business deals with unstructured data. The remaining fifteen percent (15%) deals with structured data and is accomplished by more formal business processes, either through vertically focused business applications (like accounts receivables, payroll, inventory maintenance, etc . . . ) or through specifically mapped workflows focused on specific business processes that are repeatable.

As the ad-hoc workflow is accessed by its recipients, each participant is given the option to complete their task or to reassign the workflow to someone else. As the workflow is reassigned, the underlying mapping of the workflow is managed by this application, eliminating a level of complexity for the end user.

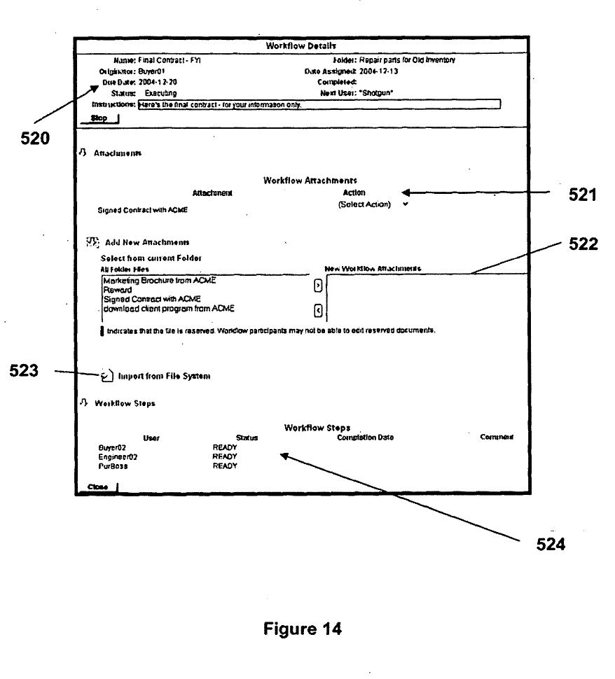

FIG. 14 shows the user interface to perform the work associated with a workflow. Detailed workflow information 520 shows the instructions for the workflow and its present status. Files previously attached to the workflow are available for appropriate action by user 521. User can view the documents and their version history 521. User may be able to edit the documents if his permission level allows and he is the current recipient of the workflow. User can also make copies of the files for their own use. User may also add copies of files from the current folder the user has opened to the workflow. User can highlight the desired files from all folder files box 522b and then select migration button 522c. User will then see the files listed in new workflow attachments box 522. User 521 may also add copies of files that have not been imported into EM. The embodiment allows the import of any electronic file from any media source. User can select import form file system button 523, and then navigate to any media source the user's computer has access to and then select the desired file. Workflow steps 524 allow the user to monitor the progress of the workflow.

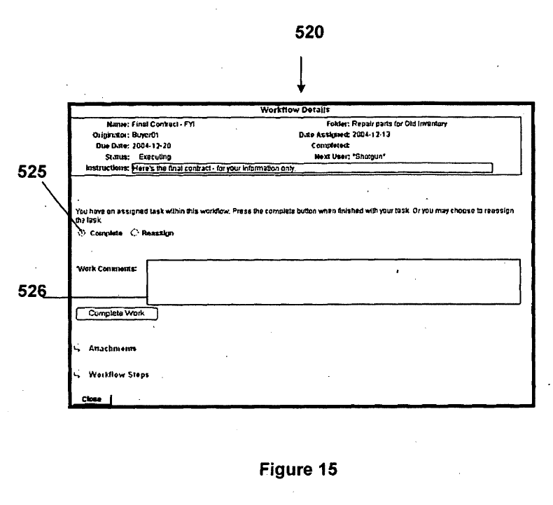

FIG. 15 shows how the workflow is executed 520. The user interface is used either to indicate completion of this recipient's work or to reassign workflow 525 to another user. The latter is as easy as picking the user name from a drop down list (not shown). In either case, the user is required to enter comments 526 before his submission of ‘complete’ or ‘reassign’ will be accepted.

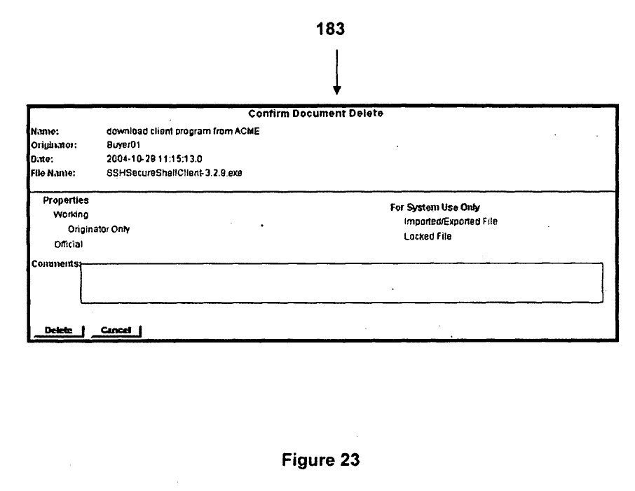

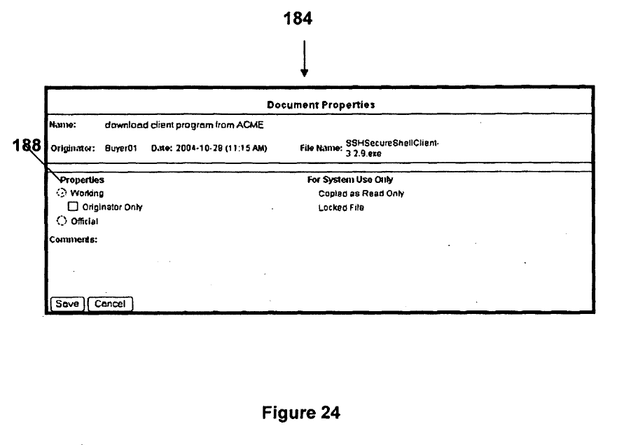

FIG. 16 shows the user interface for creating memos. Memo 200 feature of the present embodiment provides another means of handling unstructured data. Conceptually, a memo 200 is simply a note left in a folder, which may or may not be related to a specific electronic file. The user selects the type of memo to create 201. Examples of these types are “memos for the record” and “phone messages”. The user provides the subject of memo 200. He may indicate one of the electronic files in the folder to associate with this memo. He fills in the actual text of memo 200. Memos have many of the same action options as imported electronic files, including the ability to set states 202. See the discussion on document properties described with FIG. 23-24.

FIG. 17 shows the user interface for creating projects 160. A “project” in this embodiment is a collection of one or more folders, with a separate set of identifying information. A set of identifiers 161 is entered that have been established for projects 160. As in creating folders and typing in the identifying information for the folder, each project has its own identifying information. In this example, it is “description” and “keywords”. A user interface for selecting folders 162 within functional areas is provided. Another way of locating folders to include in the project is by searching on folder 163 for Identifiers 112 using a method very similar to the project/folder/document search explained earlier.

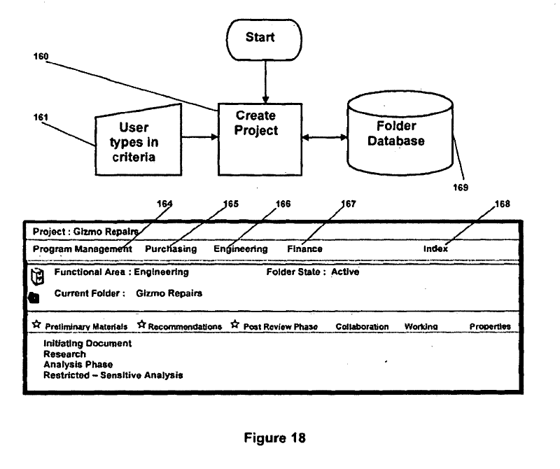

FIG. 18 shows the flow for creating projects and the elements of a created project. As detailed in FIG. 17, the user provides identifying values for the project and specifies criteria 161. The project is created 160 and the results are stored in folder database 169. In this figure, project management 164, purchasing 165, engineering 166 and finance 167 show the functional areas that have a folder included in this project example. These functional areas 164-167 are for illustration purposes and not meant to limit the scope of a user's needs. A project's index 168 is a selected subset of the tabs that are part of the composite group of tabs from all of the folders represented in the project. Its purpose is to facilitate navigation through the project.

FIG. 19 shows chronology log 170 that is used to track events in each folder. As the folder is created, an event is logged into this list. As workflows are created and worked, events are logged 173. As users access folders and look at documents or change the status of the folder 172, events are logged. Users may add free-form comments of their own 171 to further document events.

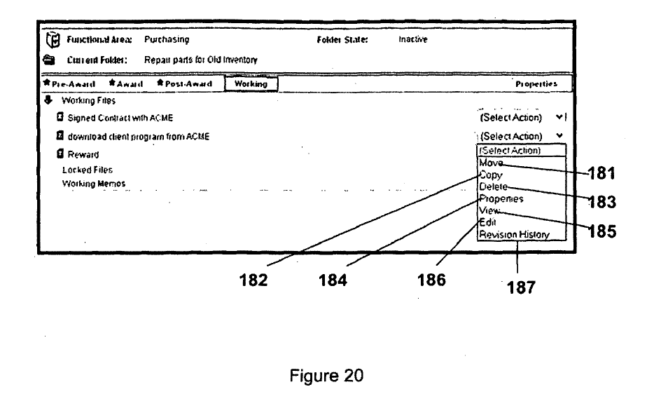

FIG. 20 shows the basic document management capabilities in this embodiment, which are available in the document's select action drop-down list 180. The capabilities include move, copy, delete, properties, view, edit, check in (not shown) and revision history. Only the options that are currently allowed, based on the user's permissions and the file's status, will appear in the select-action list.

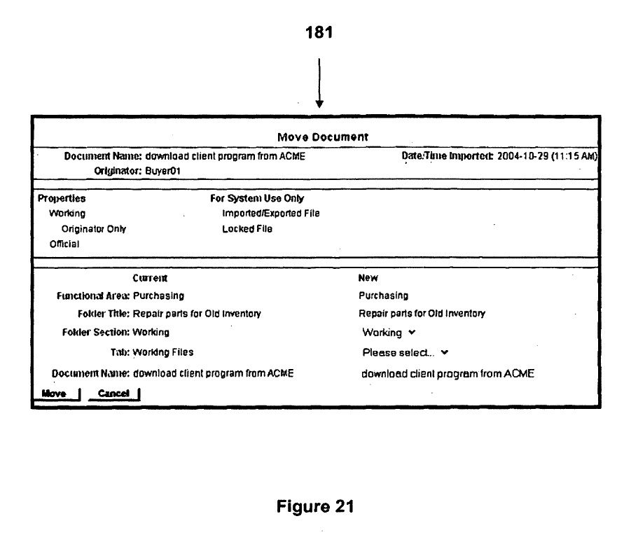

FIG. 21 shows the user interface for moving electronic files 181 from one section to another. This feature moves the document from one section and tab within a folder to a different section and tab within the same folder, as long as the user has appropriate permissions to add a file to that location. The user will select a new section from drop-down list for folder section 181b. Then the user will select a tab from the drop-down list for tab 181c.

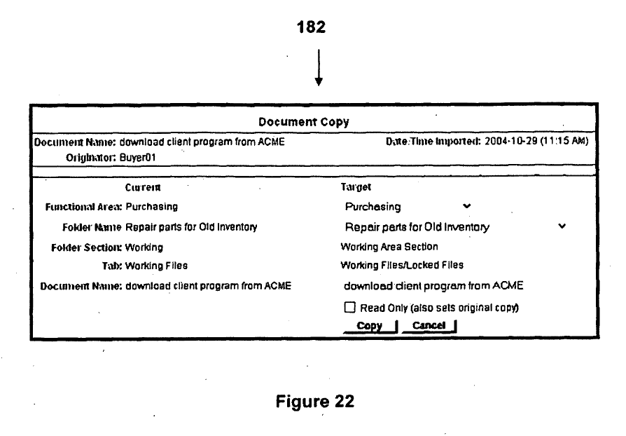

FIG. 22 shows the user interface for copying electronic files 182. The location of the resulting copy can be any folder, including the current one, as long as the user has appropriate permissions to add a file to that location and the file name is not a duplicate. The user can select a different functional area from the associated drop-down list 182b. The user can select a different folder name from the associated drop-down list 182c. The user can select a different folder section from the associated drop-down list 182d. The user can select a different tab from the associated drop down list 182e.

FIG. 23 shows the user interface for deleting electronic files 183. The user sees the document's identifying information on this screen. This option will not be available to users who do not have the appropriate permission level. As a safeguard, EM requires the user to confirm this action before selecting the delete button 183b.

FIG. 24 shows the user interface for changing document properties 184. This includes choosing between working and official status and toggling the originator-only flag on and off 188. When a file has been marked as official, it cannot be edited or deleted. When a file is flagged as “originator-only”, the system will ensure that the originator of that file is the only one who can change the contents or the status of that file.

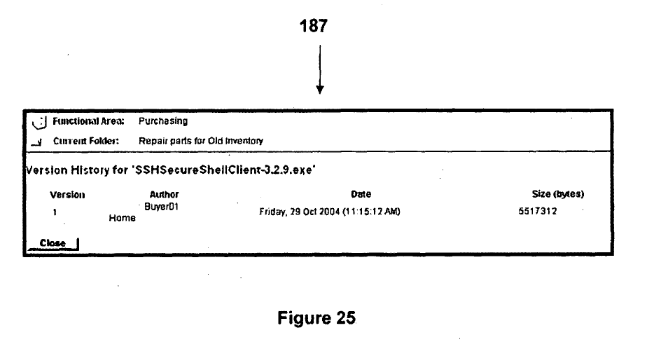

FIG. 25 shows that the user can track previous versions of an electronic file 187. Each time a change is made to a file a new version is created. Version history allows a user to view the contents of each earlier version, to see at a glance who was responsible for creating that particular version, and to see when it was created.

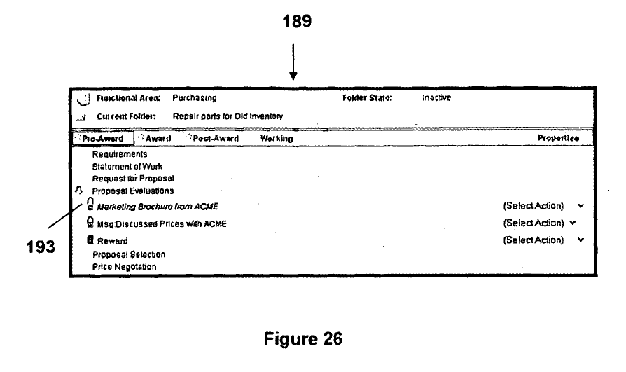

FIG. 26 shows how different status indicators are shown to user 189. For example, files that have been locked 193 as a result of locking down a folder are indicated with a padlock icon. In addition, different colored file icons can be used to show official files, such as showing working files, and so on (not shown).

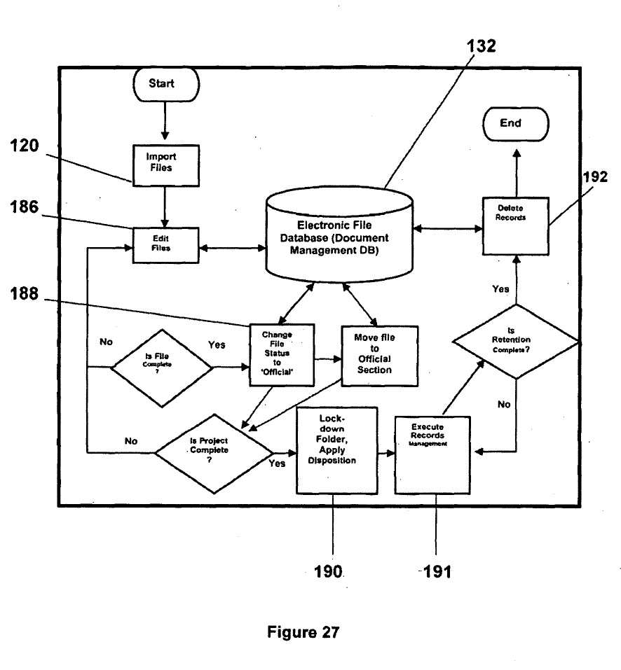

FIG. 27 is a process flow for the lifecycle of an electronic file. After a file has been imported 120 into this embodiment, it is available for editing 186 and for collaborative efforts, all the while stored in a secured, non-visible, database 132, with a full set of permissions. When the file has been completed, it is marked as “official” 188 and is not available for further edits. When all work is completed, the entire folder can be “locked down” 190. This means that no files in the folder can be edited. Once a folder has been “locked-down” 190, a records retention policy 191 may be applied. This embodiment will allow a user with appropriate permissions to delete the folder once the retention period has expired 192. All the files in the folder will be destroyed, but the essence (metadata or identifiers and the chron log) will be maintained for the life of the application.

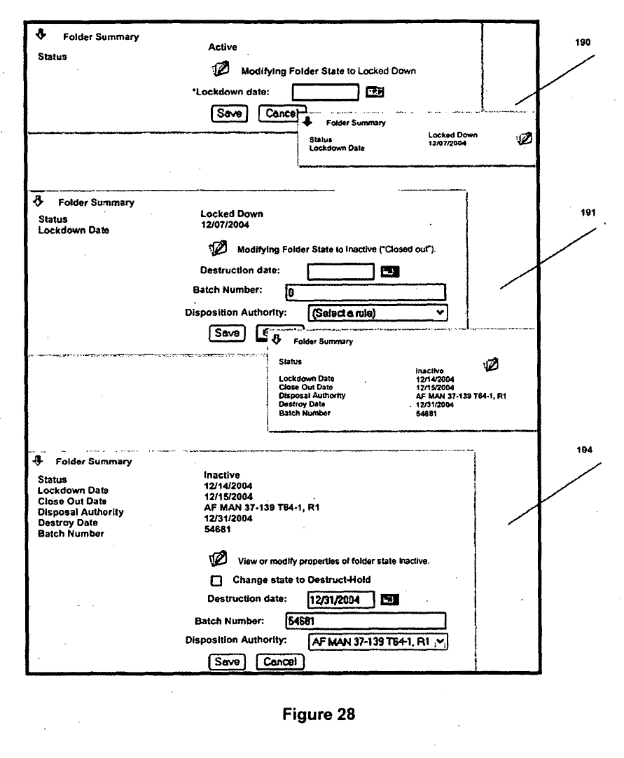

FIG. 28 shows a more detailed look at the records management capability of this embodiment. The user interface to lock down folder 190 is shown along with the user interface to apply the retention policy information to folder 191, which can include destruction date, batch number, and the approved disposition authority. The user interface for putting a hold on the folder to ensure that it is not deleted 194 is also provided. This can be used when extenuating circumstances require that information be available for a longer time than was originally determined. Once the hold is lifted, and the retention period has expired, the folder is available for destruction.

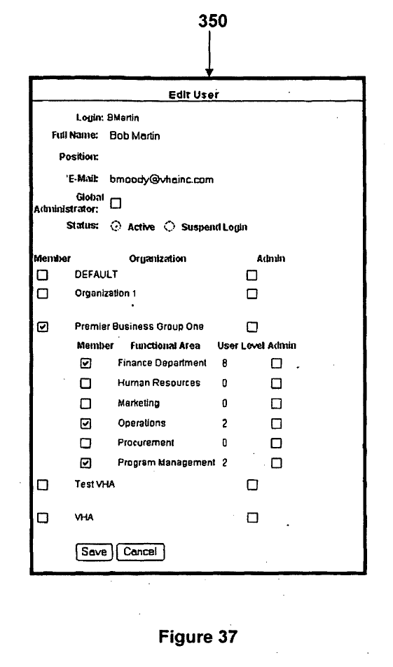

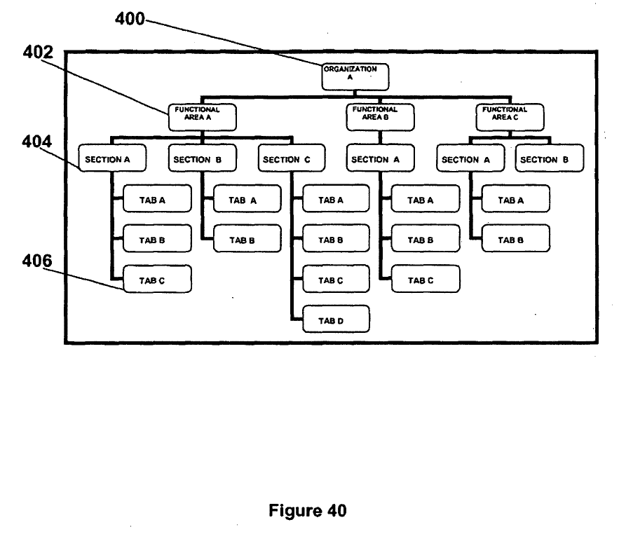

The next set of figures detail the functionality available in the configuration tool included as part of this embodiment. This module allows the user to customize his implementation of this embodiment. FIG. 40 shows how the configuration tool handles the data that defines the specific hierarchical structure for each implementation. Organizations 400 are created first. Functional areas 402 are derived from that umbrella organization 400. Sections 404 can be created under each functional area 402. Finally, tabs 406 are created under sections 404. FIG. 37 shows how users are then created 350 independently from this structure, assigned to appropriate organizations, modifying permission levels for that user in each appropriate functional area 402.

FIG. 29 shows the user interface for creating and managing the organizations for the implementation 300. This embodiment's versatility is shown by the organization searching mechanism 301 that is used throughout this module. Users can just click on the search button to search all organizations, or add any part of one of the available fields to use the typed information as search criteria. For example if the user wants to find all the organizations that have “sales” as part of the organization name and has a person named “Joe” as part of the organization, he can just type “sale” or “sales” in the organization name and “Joe” in the user name field then click search. This searching mechanism 301 works the same throughout the rest of these figures. Additionally, as the results are displayed for the user, the he can select which column will be the basis for sorting the contents. Clicking on the directional arrow icon next to column name 302, selects that column and also allows the user to toggle between ascending and descending order. This also operates in the same fashion throughout this module.

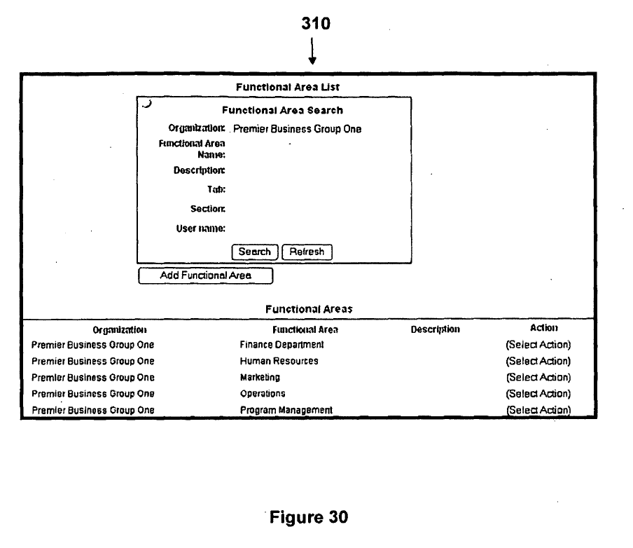

FIG. 30 shows the user interface for creating and managing functional areas for the implementation 310. The user can create a new functional area by selecting add functional area button 310d. To search for existing functional areas, the user can enter identifying information 310b, and then select Search button 310c. The embodiment then provides the user with a listing of relevant functional areas 310e. Then the user may select a functional area's corresponding select action drop-down menu 310f to take further action.

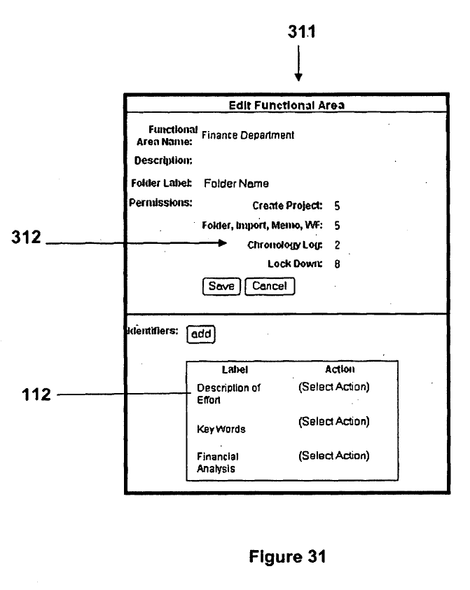

FIG. 31 shows more of the details for editing functional areas 311. Each functional area has its own specifically assigned permission levels 312. These permissions relate to actions that occur at the folder level. This embodiment of the EM provides numerous numeric permission levels. This allows the EM to easily assign roles to users to allow them to take action. But this also allows for special security needs. For example, a company could make the permissions for creating a folder and importing documents a 5, and then could assign the users who should do those actions a permission level of 5 or higher. So anyone with permission of 4 or below would be unable to import a document. Folder identifiers 112 are added and maintained for each functional area. These folder identifiers 112 are created by the user. Any metadata that the user feels is an appropriate way to identify the folder can be created in the open-text field (not shown).

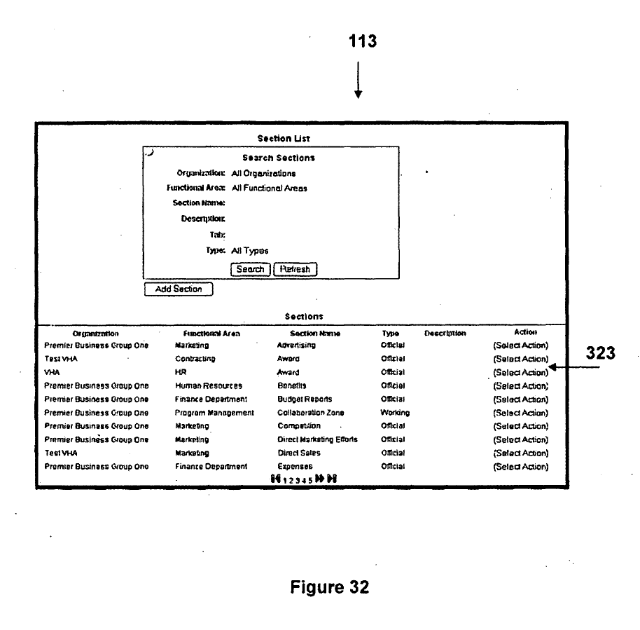

FIG. 32 shows the user interface for searching for and managing sections 113. The user can create a new section by selecting add section button 113d. To search for existing sections, the user can enter identifying information 113b, and then select search button 113c. EM then provides the user with a listing of relevant sections 113e. Then the user may select a section's corresponding select action drop-down menu 673 to take further action.

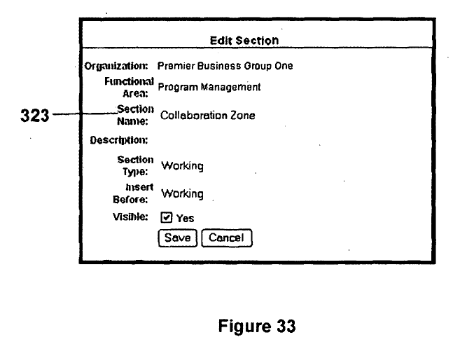

FIG. 33 shows the details for editing a Section 672b. Sections can be created and used as official sections or working sections by using section type drop-down menu 323b. Sections can be ordered by using insert before drop-down 323. A section will only be visible if visible box 323c is checked.

FIG. 34 shows the user interface for creating and managing tabs 321. The user can create a new tab by selecting add functional area button 321d. To search for existing tabs, the user can enter identifying information 321b, and then select search button 321c. EM then provides the user with a listing of relevant tabs 321e. The user may select a tab's corresponding select action drop-down menu 321f to take further action.

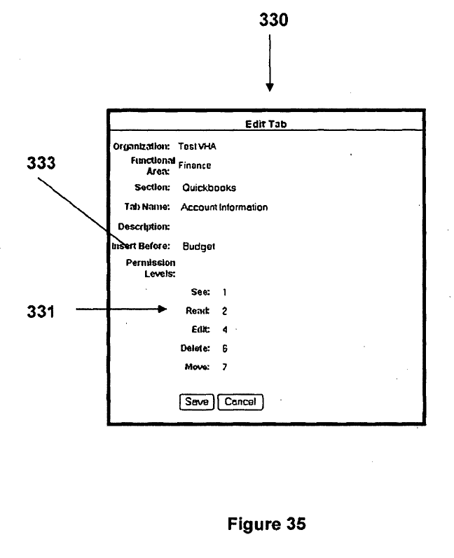

FIG. 35 shows more of the details for editing tabs, assigning a tab to a section, managing the order of the tabs, and setting the permission levels for each tab 330. The user controls the order in which tabs display within a section by using the insert before drop-down menu 333. Tab level permissions 331 relate to actions appropriate to the electronic files that the tab will contain, including see the tab, read a document in that tab, edit the document in that tab, delete the document in that tab, and move the document in that tab. EM provides numerous numeric permission levels. This allows EM to easily assign roles to users to allow them to take action and also allows for special security needs. FIG. 33 discussed permission levels for folder level actions. FIG. 35 now turns to tab level actions. For example, if the tab has a read permission of 2 and an edit permission of 4, a user with a level 3 permission can read the document that resides in the tab, but cannot edit the document.

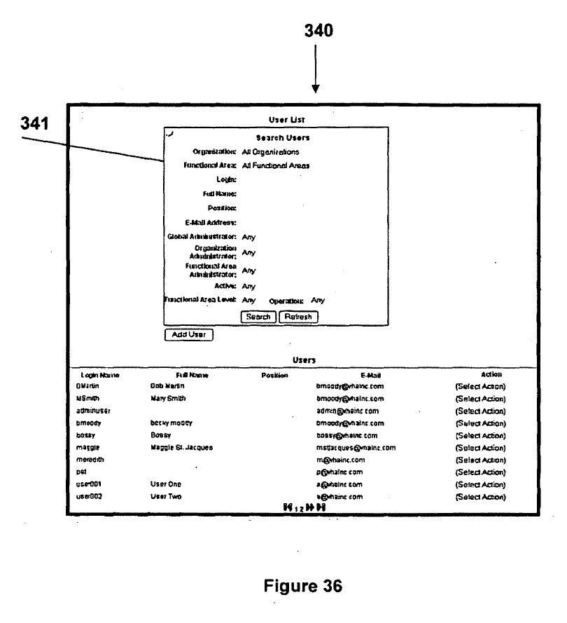

FIG. 36 shows the user interface for creating and managing users 340. Detailed search parameters 341 are available for searching for users. The user can add a new user by selecting add user button 341c. To search for existing users, the user can enter identifying information 341, and then select search button 341b. EM then provides the user with a listing of relevant user 341d. The user may select a user's corresponding select action drop-down menu 341e to take further action.

FIG. 37 shows the user interface for creating users 350. The user can assign them to organizations 351b by checking the boxes, assign them to functional areas 351c by checking the boxes, and assigning the appropriate permission levels 351d for the user by entering a numeric value.

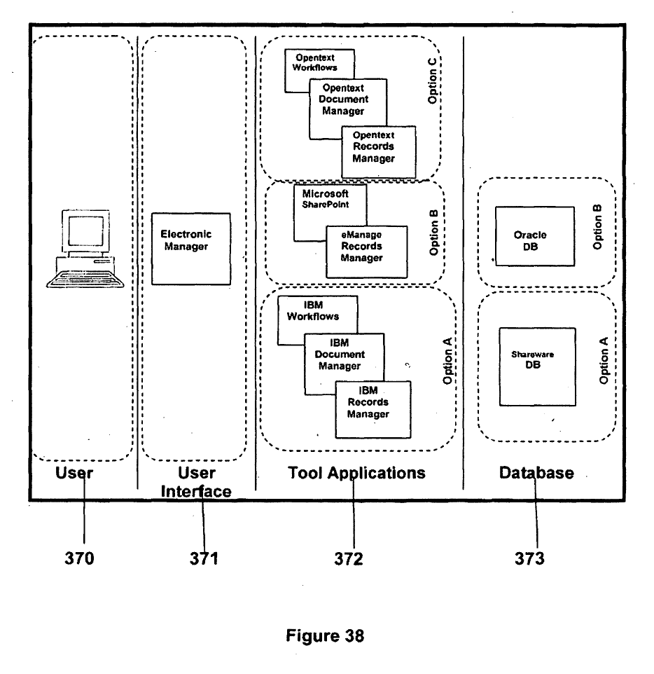

FIG. 38 depicts the layers that comprise EM. As shown the layers can include a user layer 370, user interface layer 371, a tool applications layer 372, and a database layer 373. One of the key benefits of this particular solution is that it is very modular in its construction. This means that the same EM user interface 371 can be established and other pieces swapped out and replaced. This embodiment is not limited by the choice of any one particular database. The embodiment can be formatted to run on any type of database software. This embodiment can operate with different third-party applications for workflows, document management and records management. This gives the user various suites of tools they could utilize. This embodiment is built to allow a technical administrator to swap out those tools and replace them with another set of tools, without interruption to the user interface. This eliminates user retraining.

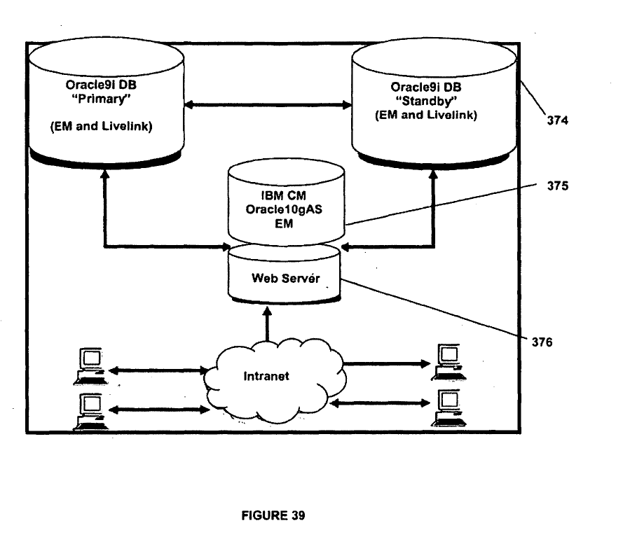

FIG. 39 shows, an example, generic architecture that would be used in one implementation utilizing a database 374 and Document Management/Records Management (DM/RM) tools that also used the database 374. In this example, the EM application runs under a document manager database 375 behind a web server 376.

The embodiments of the present invention also provide the users with a system and/or method for measuring the timeliness of structured and unstructured data and processes on a perpetual, real time basis. These instantaneous alerts and metrics can be set up and provided without the need for any programming using the invention's table driven approach.

FIG. 40 shows how the configuration tool handles the data that defines the specific hierarchical structure for each implementation. Organizations 400 are created first. Functional areas 402 are derived from that umbrella organization 400. Sections 404 can be created under each functional area 402. Finally, tabs 406 are created under sections 404. FIG. 37 shows how users 350 are then created independently from this structure, assigned to appropriate organizations, modifying permission levels for that user in each appropriate functional area 402.

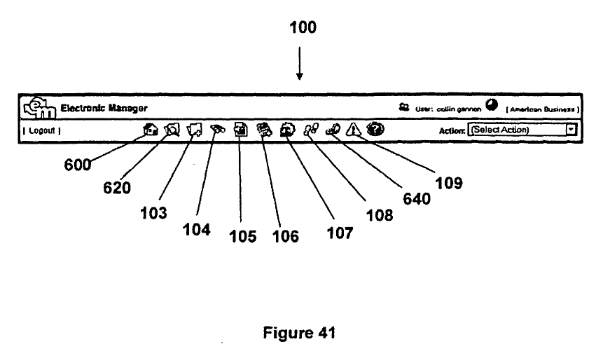

FIG. 41 is another embodiment of the tool bar 100 with navigation icons that are not contained in the embodiment of FIG. 1. In addition to the icons shown in FIG. 1, tool bar 100 also contains these icons: home page 600; current folder 620; links 640; and alerts history 109.

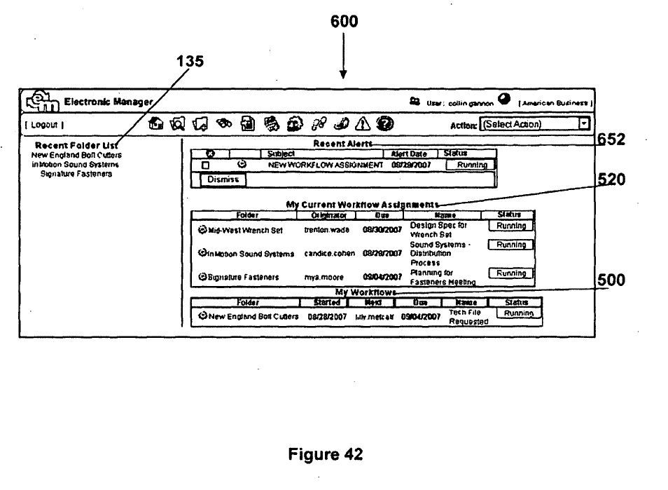

FIG. 42 illustrates how this embodiment supports the user work session with a personalized home page 600, a unique starting point for each user. Home page 600 summarizes recent activity of the individual user, and provides direct links to folders and workflows. This embodiment uses color-coding status representations (not shown) to recent alerts 652, my current workflow assignments 520, and my workflows (workflows initiated by user) 500. This provides an at-a-glance assessment of an individual user's work efforts. This color-coding informs the user when a workflow 500 is on-time, and provides warning alerts 652 that signal the effort is approaching a due date, the effort is approaching the due date, or the effort is past due. The embodiment provides the user with direct links to their tasks. By clicking on an item in recent alerts 652 list, my current workflow assignments 520, and my workflows (workflows initiated by user) 500, the user is taken directly to that item. Home page 600 also allows the user to reference and access recent folder list 135. This lists the last five folders in which they have been working, as well provides direct links to those folders.

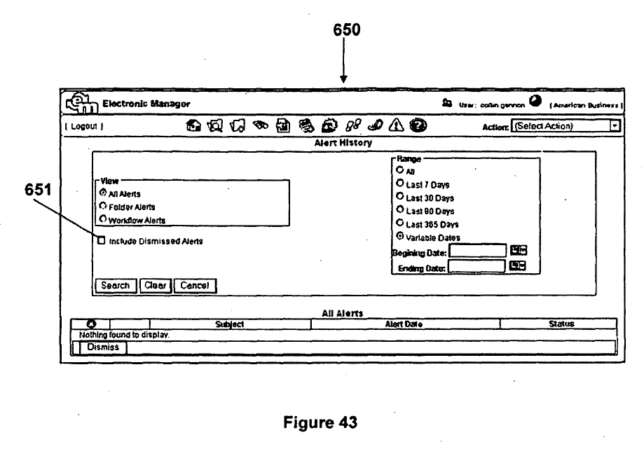

FIG. 43 displays the utility screen for searching of alerts history 650 that have been delivered to an end user. This option allows for the user to search alerts 650 by types or by date ranges. The embodiment accumulates and stores all alerts 650, including dismissed alerts 651, which are also searchable. For example, alerts 650 are generated to the identified parties when a folder or section is approaching a timeline set forth in the metrics of a particular folder.

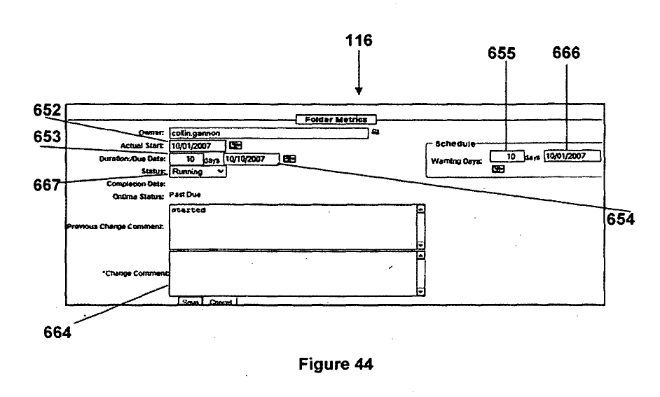

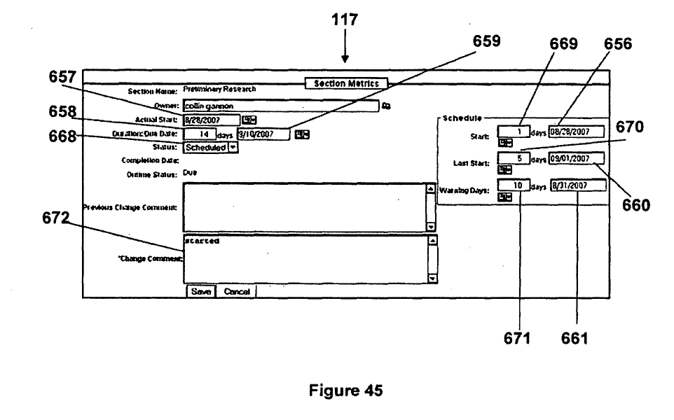

FIG. 44 illustrates the various types of folder metrics 116 that may be captured and managed. The embodiment utilizes two separate components to accomplish this, both the configuration tool 300 as referenced in FIG. 1, and the user interface as seen in FIG. 44 and FIG. 45. It is important to note that this screen and the information are protected by user permissions 350, as shown in FIG. 37.

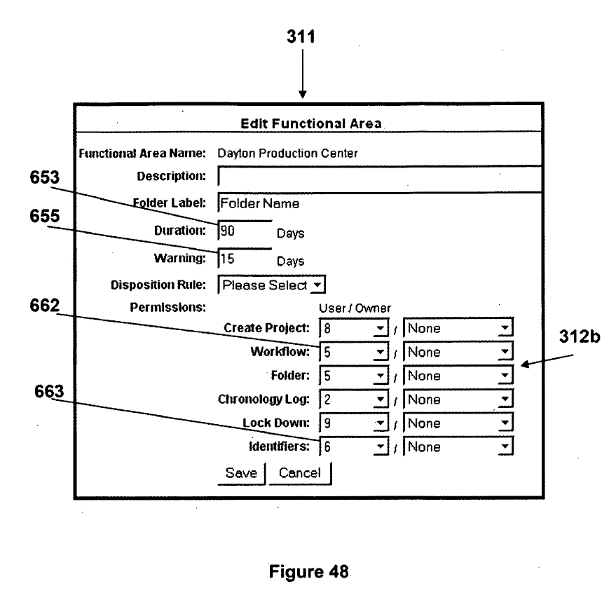

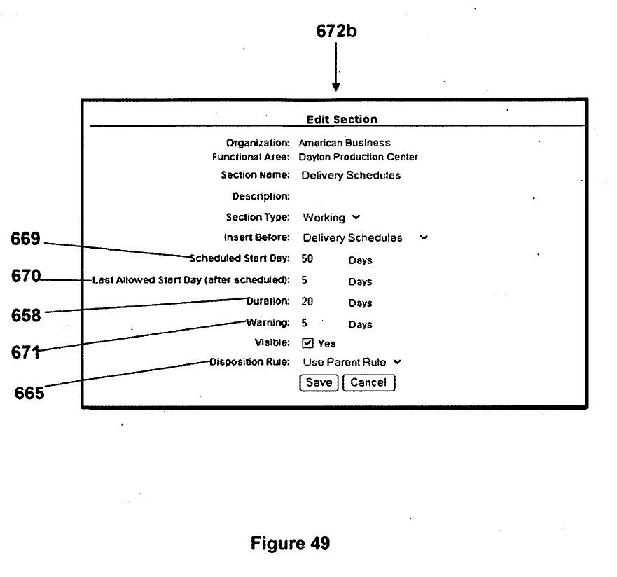

First, the user configures the business rules in configuration tool 300 referenced in FIG. 1. Specifically, the user will set up pre-defined values based on those business rules in said configuration tool relating to folder metrics 116. FIG. 48 shows where in the configuration tool the user will define duration 653 and warning day 655. Also the user enters some pre-defined values in the configuration tool relating to the section metrics 117 which are seen in FIG. 45. FIG. 49 shows edit section 672 page. This shows where the user will define the scheduled start day 669, duration 658, last start day 670 and warning day 671 in the configuration tool. Secondly, FIG. 44 shows from inside the user interface of the embodiment, where the user sets an actual start date 652.

The embodiment processes this entered data from the user interface, and along with the pre-defined duration 653 and warning day 655 from the configuration tool, automatically calculates values for due date 654 and warning date 666. The embodiment will automatically populate the calculated values in the empty field boxes for due date 654 and warning date 666 in FIG. 44.

A secondary simultaneous and automatic action occurs at section metric level 117, seen in FIG. 45. From inside the user interface, the user sets actual start date 652 at folder metric 116 level in FIG. 44. Then EM processes the entered data from the user interface, along with the previously entered values of scheduled start day 669, duration 658, last start day 670 and warning day 671 from the configuration tool and calculates values for scheduled start days 669 and scheduled start date 656. EM automatically populates the calculated values in the empty field boxes for scheduled start days 669 and scheduled start date 656 on the individual section metric 117 page, FIG. 45.

FIG. 45 illustrates the various types of section metrics 117 that can be captured and managed by this embodiment. EM utilizes two separate components to accomplish this, both configuration tool 300 as referenced in FIG. 1, and the user interface as seen in FIG. 44 and FIG. 45. It is important to note that FIG. 45 and the information contained on that screen are protected by user permissions 350, as shown in FIG. 37.

First, a user configures the business rules in configuration tool 300 as referenced in FIG. 1. FIG. 48 shows where the user will define the duration 653 and warning day 655 in the configuration tool. Also the user enters some pre-defined values in the configuration tool relating to section metrics 117 which are seen in FIG. 45. FIG. 49 shows edit section 672 page. This shows where in the configuration tool the user will define scheduled start day 669, duration 658, last start day 670 and warning day 671. Secondly, from inside the user interface of the EM in FIG. 45, the user sets an actual start date 657.

EM processes this entered data from the user interface and, along with the pre-defined values from the configuration tool relating to section metrics 117 on edit section 672 page, shown in FIG. 49, namely scheduled start day 669, duration 658, last start day 670 and warning day 671, automatically calculates values for due date 659, last start date 660 and warning date 661. EM automatically populates the calculated values in the empty field boxes due date 659, last start date 660, and warning date 661, shown in FIG. 45.

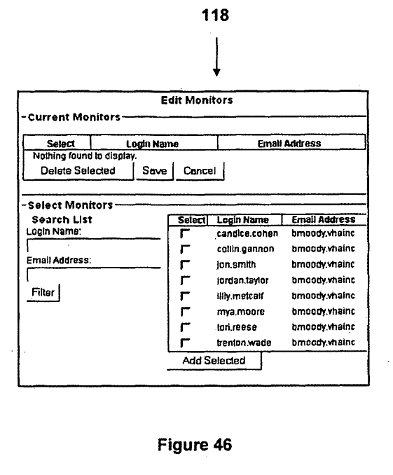

FIG. 46 introduces the feature for folder monitors 118. Assignment of an individual as a folder monitor 118 will effectively keep this individual automatically informed when timelines are adjusted or when due dates are approaching by use of alerts. These alerts are sent either when folder metrics 116, shown in FIG. 44, are adjusted manually, or when the system generates timeline status ‘due date approaching’ or ‘due date past due’ alerts, shown on the home page 600, shown in FIG. 41. This embodiment provides a complete user search, selection and save transaction.

For example, the use of metrics shown in FIGS. 44, 45 and 46 allows a user to set a timeline for the sections and folders to assist in identifying for the folder monitors when a section or folder is approaching its due date or is past due. It also allows the appointment of individuals to become monitors of a folder.

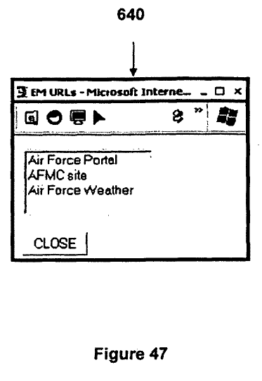

FIG. 47 demonstrates the embodiment's feature to allow a customer to define a set of approved links 640 for the user community to click and access. This feature opens a separate browser session for the end user, independent of the session that is hosting the user session. When the user closes this link 640 they do not close out of the user session with this application. For example, links 640, demonstrates the ability of the links icon to access websites that have been previously identified by the administrator.

FIG. 48 is a second view showing a screenshot 311 of the edit functional area capability of the configuration tool that allows for an expansion of permission 312 options, originally shown in FIG. 31. This expanded capability includes the separation of workflow 662, the addition of identifier 663, and the addition of role based permission 312b. This expansion of the numeric permission adds greater depth to controlling access to information within the embodiments and in controlling the ability to manipulate key features of the embodiments. FIG. 48 supports the ability to establish folder level metrics 116, as seen in FIG. 44. For example, permissions 312b demonstrates the use of permissions to determine who can or cannot carry out specific functions within a functional area. Permissions can be set to restrict access by the numeric permission level each user is assigned, or by the specific role that user may be assigned. Also, FIG. 48 allows specific time standards to be set up for measuring a specific process. These time standards, duration 653 and warning day 655, establish accountability for the unstructured process in terms of its timeliness, i.e. is the process on time, almost late or late to the standards established.

FIG. 49 is a second view of edit section 672b FIG. 33. In this version, not only can the user select between working or officially name the section, define the order of the placement, and make the section visible, the user can also define metrics at section level 117, as shown in FIG. 45. The following values are set here: scheduled start day 669; duration 658; last start day 670; and warning day 671. Also, the user can now create a rule for disposition 665 of the document. This allows the company to comply with legal rules about document retention.

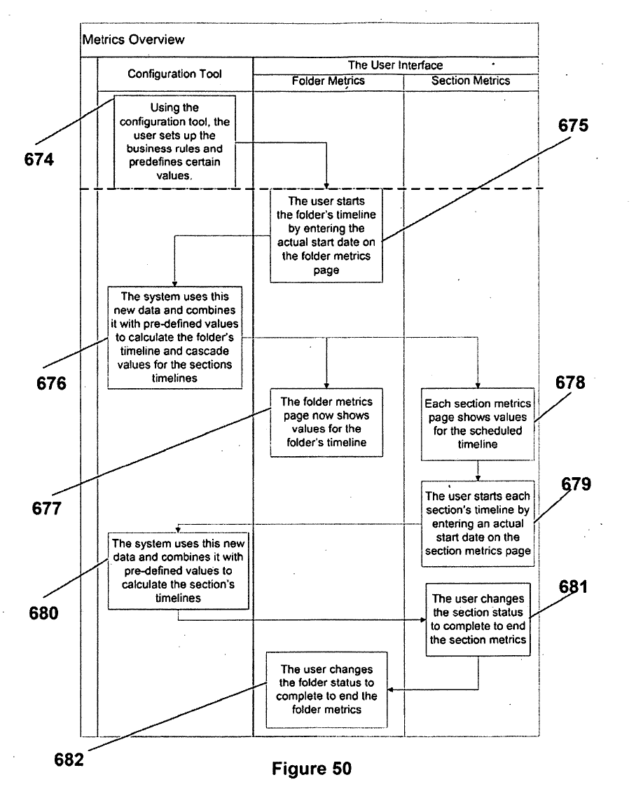

FIG. 50 is a flowchart 673 providing an overview of the methodology for the user to initiate metrics in order to manage timelines. This embodiment utilizes a visual representation in scheduling a process. This is done by the use of metrics. In order to initiate metrics within a folder, the user must have permission 312 to perform the action, which is granted in the configuration tool as seen in FIG. 37. Metrics are initiated, updated and completed by the folder owner only. As discussed earlier, the embodiment utilizes two components, the configuration tool, and the user interface. In step 674, the user, who is likely an administrator, uses the configuration tool to enter business rules for their company. This includes setting user permissions, as shown in FIG. 37, and setting up pre-defined values for both the folder and the section. Every folder and section created in that functional area will inherit the same pre-defined values. For the folder, the pre-defined values entered in the configuration tool are duration 653 and warning day 655, shown on FIGS. 31 and 48. FIG. 44 shows where these values appear in the user interface. For the section, the pre-defined values entered in the configuration tool are scheduled start day 669, duration 658, last start day 670 and warning day 671, shown in FIG. 49. FIG. 45 shows where these values appear in the user interface.

Many users will never be responsible for the administrative actions in step 674. Rather, they will enter the application at this point and only use the user interface component. In step 675, the user starts the folder's timeline by entering actual start date 652 on folder metrics page 116, shown in FIG. 44.

In step 676, the system uses this new data, and combines it with the pre-defined values of duration 653 and warning day 655 to calculate folder's due date 654 and warning date 666, and the system will cascade each section's scheduled start day 669 and scheduled start date 656, FIG. 45. The user will not see this activity. Instead, step 677 occurs simultaneously with step 678. In step 677, the folder metrics page now shows values for the folder's timeline, folder's due date 654 and warning date 666, and the user will see the immediate results on folder metrics page 116, shown in FIG. 44. The user is able to adjust the timelines using this page of the user interface, if desired, without affecting the timelines of any other folder, or needing to access the configuration tool. Concurrently, in step 678, each section metrics page shows values for the scheduled timeline, section's scheduled start day 669 and scheduled start date 656, on section metrics page 117, as seen in FIG. 45. The user is able to adjust the section timelines if desired using this page of the user interface, without needing to access the configuration tool.

Each individual section's timeline must be managed once the folder's timeline has been started, or the folder will be adversely affected. In step 679, the user starts each section's timeline by entering an actual start date 657, on section metrics page 117, shown in FIG. 45. The user must also enter a required change comment 672 to support this action.

In step 680, the system uses this new data and combines it with pre-defined values of scheduled start day 669, duration 658, last start day 670 and warning day 671, to calculate due date 659, last start date 660, and warning date 661 for that section. Once the user has started the first section, the other sections now have actual calendar scheduled start dates 656 to help with project management.

In step 681, the user changes the section status to complete to end the section metrics. Once each section is ready to be completed, the user changes status 668 to completed on section metrics page 117, FIG. 45. Each section must have a complete status in order to complete the folder.

Step 682 mentions that the user changes the folder status to complete to end the folder metrics. Eventually, when each section has a status of completed, the user goes to folder metrics page 116, FIG. 44, and changes folder status 667 to completed to end the folder's timeline.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the embodiments of the invention have been described in detail with particular reference to these preferred embodiments, other embodiments can achieve the same results. It is anticipated that the software that utilizes the method will continue to change the appearance of its user interface and evolve. Variations and modifications of the present invention will be obvious to those skilled in the art and it is intended to cover in the appended claims all such modifications and equivalents. The entire disclosures of all references, applications, patents, and publications cited above, are hereby incorporated by reference.

1. (canceled)

2. A method for managing a process and storing of electronic files utilizing an ad hoc workflow for both structured and unstructured data, the method comprising the steps of:
a) generating a file structure that mirrors the process wherein the file structure comprises business rules and permissions tailored for a specific user, wherein the file structure comprises sections which comprise steps of the process and tabs which comprise substeps of the process;
b) creating at least one folder comprising the electronic files in the file structure based on the business rules;
c) setting up alerts and metrics for at least one member of the group consisting of each folder of the at least one folder, each section of the sections and each tab of the tabs;
d) searching a status of the alerts and metrics by at least one authorized user; and
e) accessing the alerts and metrics by the at least one authorized user, on demand.

3. The method of claim 2 wherein the step of searching comprises searching by at least one member from the group consisting of searching by a folder name, a description of a document, a document name and an indexed identifier.

4. The method of claim 2 further comprising the step of modifying the alerts and metrics by the at least one authorized user.

5. The method of claim 2 wherein the step of setting up alerts and metrics comprises setting up unique alerts and metrics for the specific user.

6. The method of claim 5 further comprising the step searching for a status of at least one member of the group consisting of a workflow, a folder, a section and a tab using the unique alerts and metrics.

7. The method of claim 2 wherein the step of searching comprises searching in real time.

8. The method of claim 2 wherein the step of accessing comprises accessing in a predetermined pattern.

9. A system for managing a process and storing of electronic files utilizing an ad hoc workflow for both structured and unstructured data, the system comprising:
a processor:
means for generating a file structure that mirrors the process wherein the file structure comprises business rules and permissions tailored for a specific user, wherein the file structure comprises sections which comprise steps of the process and tabs which comprise substeps of the process by the processor;
means for creating at least one folder comprising the electronic files in the file structure based on the business rules by the processor;
means for setting up alerts and metrics for at least one member of the group consisting of each folder of the at least one folder, each section of the sections and each tab of the tabs by the processor;
means for searching a status of the alerts and metrics by at least one authorized user by the processor; and
means for accessing the alerts and metrics by the at least one authorized user, on demand.

10. The system of claim 9 wherein the means for searching comprises a means for searching by at least one member from the group consisting of searching a folder name, a description of a document, a document name and an indexed identifier.

11. The system of claim 9 further comprising a means for modifying the alerts and metrics by the at least one authorized user.

12. The system of claim 9 wherein the means for setting, up alerts and metrics comprises a means for setting up unique alerts and metrics for the specific user.

13. The system of claim 12 further comprising a means for searching for a status of at least one member of the group consisting of a workflow, a folder, a section and a tab using the unique alerts and metrics.

14. The system of claim 9 wherein the means for searching comprises a means for searching in real time.

15. The system of claim 9 wherein the means for accessing comprises a means for accessing in a predetermined pattern.

16. A computer program product, comprising:
computer readable medium comprising:
code that causes management of a process and storage of electronic files utilizing an ad hoc workflow for both structured and unstructured data, the computer code comprising:
code that causes a file structure to be generating that mirrors the process wherein the file structure comprises business rules and permissions tailored for a specific user, wherein the file structure comprises sections which comprise steps of the process and tabs which comprise substeps of the process;
code that causes at least one folder to be created comprising the electronic files in the file structure based on the business rules;
code that causes alerts and metrics to be set up for at least one member of the group consisting of each folder of the at least one folder, each section of the sections and each tab of the tabs;
code that causes a status of the alerts and metrics to be searched by at least one authorized user; and
code that causes the alerts and metrics to be accessed by the at least one authorized user, on demand.

17. The computer program product of claim 16 wherein the code that causes the alerts and metrics to be searched comprises code that causes a search for at least one member from the group consisting of a folder name, a description of a document, a document name and an indexed identifier.

18. The computer program product of claim 16 further comprising code that causes the alerts and metrics to be modified by the at least one authorized user.

19. The computer program product of claim 16 wherein the code that causes alerts and metrics to be set up comprises setting up unique alerts and metrics for the specific user.

20. The computer program product of claim 19 further comprising code that causes a search for a status of at least one member of the group consisting of a workflow, a folder, a section and a tab using the unique alerts and metrics.

21. The computer program product of claim 16 wherein the code that causes the alerts and metrics to be accessed comprises code that causes the alerts and metrics to be accessed in a predetermined pattern.
